(19) United States
(12) Patent Application Publication
(10) Pub. No.: US 2014/0040861 A1
(43) Pub. Date: Feb. 6, 2014

(54) METADATA DRIVEN SOFTWARE ARCHITECTURE

(71) Applicant: LG CNS CO., LTD., (US)

(72) Inventors: Hyun Jun Kim, Seoul (KR); Sang Mi Choi, Seoul (KR); Hwan Joon Choi, Gyeonggi-do (KR); Eun Hwa Lee, Gyeonggi-do (KR); Kyung In Kang, Seoul (KR); Sang Ok Song, Gyeonggi-do (KR); Hang Seub Lim, Gyeonggi-do (KR)

(73) Assignee: LG CNS CO., LTD., Seoul (KR)

(21) Appl. No.: 13/747,648

(22) Filed: Jan. 23, 2013

(30) Foreign Application Priority Data
Mar. 15, 2012 (KR) 10-2012-0026805

(51) Int. Cl. G06F 9/44

(52) U.S. Cl. CPC G06F 8/70
USPC 717/120

(57) ABSTRACT

Embodiments of the present invention provide a metadata-driven software architecture that enables multi-tenant application development. Specifically, an application development architecture is provided including a data table that stores the application-accessible data that maps to all custom objects and their fields, as defined by metadata in objects and fields. Forms, reports, work flows, user access privileges, tenant-specific customizations and business logic, and definitions of underlying data tables and indexes exist as metadata. Application components are generated at runtime using the metadata.

### TECHNICAL FIELD

In general, the present invention relates to the field of data processing. Specifically, the present invention relates to metadata driven software architecture for software as a service (SaaS) development.

### BACKGROUND

With the development of network technology, SaaS (software as a service) has become increasingly popular in the Internet field. SaaS is a mode for providing application software through the Internet, in which software providers deploy applications on a server uniformly, and tenants may subscribe desired applications from software providers through the Internet according to their practical demands and obtain applications as provided by software providers through the Internet. Unlike a traditional (on-premise) mode in which software applications are purchased and installed on the customers' computers, in SaaS mode, tenants utilize functions of desired application software by using web-based applications as subscribed from software providers. For example, tenants may utilize the web-based application for customer relationship management, online sales, commodity inventory management, order tracking, and so on.

An advantage of SaaS is that tenants do not need to maintain the software, but software providers are responsible for all work related to management and maintenance of the application. In this case, tenants who rent/utilize SaaS services do not need to purchase, construct, or maintain infrastructure related to traditional applications, and they do not need to have expertise in application software maintenance. They only need to have the ability to utilize the application software.

Compared with on-premise software technology, SaaS boasts a significant difference in that the application employs a multi-tenant mode during operation. Multi-tenancy is a model of software architecture. Under this model, only a single instance of the application runs on servers of SaaS providers (i.e., multiple tenants of the application need to share this single instance). Multi-tenancy is relative to single-tenancy. In a single-tenant architecture, one instance of the application only serves one tenant.

Traditional software systems are typically created for a dedicated purpose with limited optional behaviors and features. Major feature and behavior changes to traditional software systems require significant development efforts and the creation of new versions. Systems that are created to be flexible require extensive custom development work to meet custom requirements.

However, an SaaS system is traditionally not as configurable as an on-premises software system. Thus, there is a need to provide a system and a method for providing an SaaS that does not have the configurability constraints of a traditional SaaS. Heretofore, several unsuccessful attempts have been made to address these shortcomings.

U.S. Patent Application 20110179110 discloses a presentation manager configured to provide an interface requesting information regarding a proposal from a digital device over a network and receive the information on the digital device.

U.S. Patent Application 20110126168 discloses a cloud platform for managing software as a service (SaaS) resources which allows customers to consume developed SaaS applications with associated customer data.

U.S. Patent Application 20110010394 discloses client-specific data customization for shared databases in which a client-specific data field identifier for each item of a client-specific data is associated with a first client in a set of clients received at a processor associated with a software as a service (SaaS) module.

U.S. Patent Application 20110191702 discloses a system and method for polymorphic content generation in a multi-application, multi-tenant environment.

U.S. Patent Application 20100332629 discloses a secure custom application which facilitates virtually seamless migration of custom applications to and from a cloud computing environment in response to user needs.

None of these references, however, teach a method for providing an SaaS that does not have the configurability constraints of a traditional SaaS.

### SUMMARY

Embodiments of the present invention provide a metadata-driven software architecture that enables multi-tenant application development. Specifically, an application development architecture is provided including a data table that stores the application-accessible data that maps to all custom objects and their fields, as defined by metadata in objects and fields. Forms, reports, work flows, user access privileges, tenant-specific customizations and business logic, and definitions of underlying data tables and indexes exist as metadata. Application components are generated at runtime using the metadata.

A first aspect of the present invention provides a computer-implemented method for providing a metadata-driven software architecture that enables multi-tenant application development, comprising: referencing a first metadata associated with an object; referencing a second metadata associated with a field; and storing an application-accessible data associated with a tenant, wherein the application-accessible data is defined by at least one of the first metadata or the second metadata.

A second aspect of the present invention provides a system for providing a metadata-driven software architecture that enables multi-tenant application development, comprising: a memory medium comprising instructions; a bus coupled to the memory medium; and a processor coupled to the bus that when executing the instructions causes the system to: reference a first metadata associated with an object; reference a second metadata associated with a field; and store an application-accessible data associated with a tenant, wherein the application-accessible data is defined by at least one of the first metadata or the second metadata.

A third aspect of the present invention provides a computer program product for providing an on-demand database service application composer, the computer program product comprising a computer readable storage media, and program instructions stored on the computer readable storage media, to: reference a first metadata associated with an object; reference a second metadata associated with a field; and store an application-accessible data associated with a tenant, wherein the application-accessible data is defined by at least one of the first metadata or the second metadata.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an (SaaS) application development architecture according to an embodiment of the present invention.

FIG. 2 depicts a more detailed exemplary SaaS application development system according to an embodiment of the present invention.

FIG. 3 depicts an example flow diagram of metadata processing according to an embodiment of the present invention.

FIG. 4 depicts an example object metadata table schematic according to an embodiment of the present invention.

FIG. 5 depicts an example field metadata table schematic according to an embodiment of the present invention.

FIG. 6 depicts an example field metadata table according to an embodiment of the present invention.

FIG. 7 depicts an example primary key metadata table schematic according to an embodiment of the present invention.

FIG. 8 depicts an example foreign key metadata table schematic according to an embodiment of the present invention.

FIG. 9 depicts an example flow diagram for producing the object metadata table according to an embodiment of the present invention.

FIG. 10 depicts a standard object metadata table schematic according to an embodiment of the present invention.

FIG. 11 depicts a non-standard object metadata table schematic according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Generally, the systems and methods disclosed herein include and are implemented within a computer system having one or more databases and other storage apparatuses, servers, and additional components, such as processors, terminals and displays, computer-readable media, algorithms, modules, and other computer-related components. The computer systems are especially configured and adapted to perform the functions and processes of the systems as disclosed herein. As disclosed herein, the systems are illustrated in an exemplary environment in which the systems interact with one or more users directly, indirectly, or through a third party intermediary. A user includes, for example, an end user, an intermediary user, an internet user, an authorized user, etc.

The user device(s) (e.g., personal computers, smart phones, servers, laptops, and the like) operating with the systems and methods described herein preferably include conventional processors, memory, I/O capabilities and components, and programming modules and/or computer readable media that enable performance of the functions and operation of the system as described herein. The user device(s) are typically in electronic, bi-directional communication with a server/system via a wired or wireless network, for example, the user device(s) may be networked directly, indirectly, through a third party intermediary, wirelessly, over the Internet, or otherwise with the client device in conventional manner.

Similarly, the database(s) described herein will typically be in electronic, bi-directional communication with the user device(s) via a wired or wireless network. For example, the database(s) may be networked directly, indirectly, wirelessly, over the Internet, or otherwise with the user device(s). The database(s) may be implemented in one or more hardware components and may be located locally or remotely from the user device(s) all in conventional manner.

Embodiments of the present invention provide a metadata-driven software architecture that enables multi-tenant application development. Specifically, an application development architecture is provided including a data table that stores the application-accessible data that maps to all custom objects and their fields, as defined by metadata in objects and fields. Forms, reports, work flows, user access privileges, tenant-specific customizations and business logic, and definitions of underlying data tables and indexes exist as metadata. Application components are generated at runtime using the metadata.

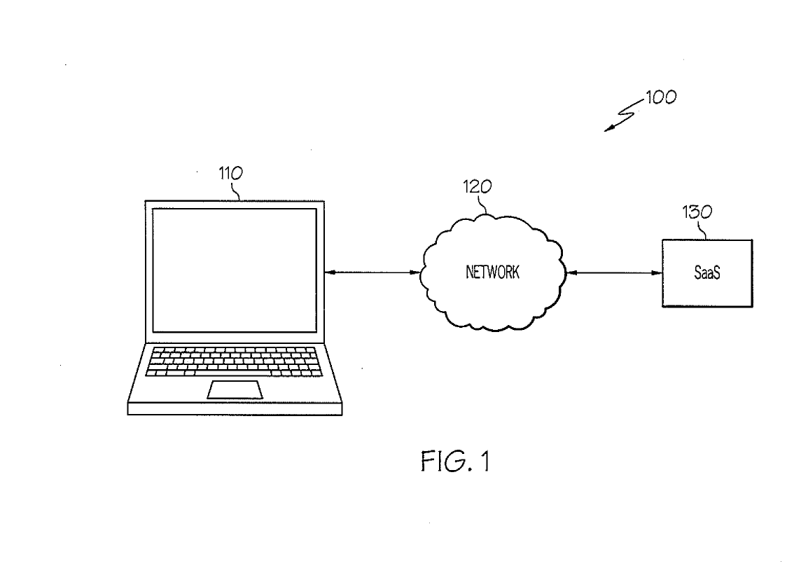

FIG. 1 depicts an exemplary software as a service (SaaS) application development architecture 100 that uses a graphical web user interface for developing, distributing, and performing an on-demand database service, in accordance with one embodiment.

The SaaS application development architecture 100 may include a user device 110, network (e.g., the Internet) 120 and the SaaS application development system (“SaaS”) 130. In one example, the user device 110 may be any device that allows the user to access an on-line or Internet site through a wireless or wired communication and receive content. Suitable user devices include PCs, laptops, smart phones, PDAs, and the like.

Network 120 is any network or combination of networks of devices that communicate with one another. For example, network 120 can be any one or any combination of a LAN (local area network), WAN (wide area network), telephone network, wireless network, point-to-point network, star network, token ring network, hub network, or other appropriate configuration. The most common type of computer network in current use is a TCP/IP (Transfer Control Protocol and Internet Protocol) network, such as the global internetwork of networks often referred to as the “Internet”, which used in many of the examples herein. However, it should be understood that the networks that the present invention might use are not so limited, although TCP/IP is a frequently implemented protocol.

The SaaS application development system 130 may reside on any server/computing device that is able to connect to the network 120 and transmit and receive data via the network 120. The user device 110 might communicate with the SaaS application development system 130 using TCP/IP and, at a higher network level, use other common Internet protocols to communicate, such as HTTP, FTP, AFS, WAP, etc. In an example where HTTP is used, the user device 110 might include an HTTP client commonly referred to as a “browser” for sending and receiving HTTP messages to and from an HTTP server at the SaaS application development system 130. Such an HTTP server might be implemented as the sole network interface between the SaaS application development system 130 and network 120, but other techniques might be used as well or instead. In some implementations, the interface between the SaaS application development system 130 and network 120 includes load sharing functionality, such as round-robin HTTP request distributors to balance loads and distribute incoming HTTP requests evenly over a plurality of servers.

The SaaS application development system 130 may provide development, editing, and publishing tools designed to allow a user to design, create, edit, store, organize, and/or publish a mult-tenant application, such as an on-demand database service. In the context of the present description, an on-demand database service may include any service that relies on a database system that is accessible over a network. In one example, the on-demand database service may include a multi-tenant on-demand database service. In the present description, such multi-tenant on-demand database service may include any service that relies on a database system that is accessible over the network 120, in which various elements of hardware and software of the database system may be shared by one or more tenants. A tenant refers to any one or more persons or entities that are capable of accessing the on-demand database service in the present description. For example, the tenant(s) may subscribe to the on-demand database service.

The multi-tenant application shares a single architecture of resources to satisfy the needs of multiple organizations (i.e., tenants). Only one set of hardware resources is necessary to meet the needs of all tenants using the multi-tenant service. Tenants can use and customize an application as though they each have a separate instance, yet their data and customizations remain secure and insulated from the activity of all other tenants. Everything used by developers and application users is internally represented as metadata, including, but is not limited to, forms, reports, work flows, user access privileges, tenant-specific customizations and business logic, and definitions of underlying data tables and indexes. Application components are generated at runtime using the metadata.

The SaaS application development system 130 may include a software as a service (SaaS) application composer for providing an on-demand database service. A user interface (UI) composer may be provided that allows for editing a graphic pattern, layout, and/or data view of a graphical user interface which is then rendered based on markup tags. A dynamic query generator may create the query defined by the rendered graphical user interface and processes the tenant's database service request. The SaaS application may be stored at an application metadata location and available to other tenants.

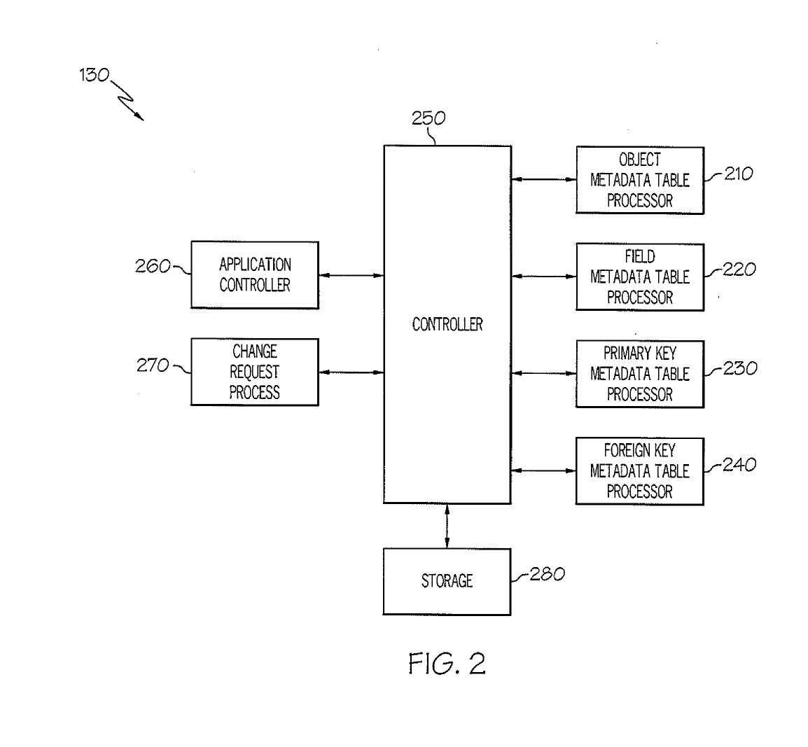

FIG. 2 depicts a more detailed exemplary SaaS application development system 130 according to an embodiment of the present invention. As shown, the SaaS application development system 130 includes object metadata table processor 210, field metadata table processor 220, primary key metadata table processor 230, foreign key metadata table processor 240, controller 250, application controller 260, change request processor 270, and storage 280. Storage 280 described herein can be implemented as single database, a distributed database, a collection of distributed databases, a database with redundant online or offline backups or other redundancies, etc., and might include a distributed database or storage network and associated processing intelligence.

When a tenant creates custom application objects (e.g., custom tables), the SaaS application development system 130 may use metadata concerning the objects, their fields, relationships, and other object definition characteristics. The object metadata table processor 210 may process metadata associated with an object metadata table. The object metadata table may store information about custom objects (i.e., tables or entities) that a tenant defines for an application, including, but not limited to, a unique identifier for an object, the tenant that owns the object, and the name given to the object. In some examples, the object metadata table may be stored in storage 280.

The field metadata table processor 220 may process metadata associated with a field metadata table. In one example, the field metadata table stores information about the custom fields (e.g., columns or attributes) that a tenant defines for custom objects, including, but not limited to, a unique identifier for a field, the tenant that owns the encompassing object, the object that contains the field, the name of the field, the field's data type, a Boolean value to indicate if the field requires indexing, and the position of the field in the object relative to other fields. In some examples, the field metadata table may be stored in storage 280.

The primary key metadata table processor 230 and second key metadata table processor 240 may process metadata associated with a primary key metadata table and a second key metadata table, respectively. In one example, the primary key metadata table stores a primary key field defined by the tenant and the second key metadata table stores a second key field defined by the tenant. The primary key metadata table and the second key metadata table may be stored in storage 280.

The SaaS application development system 130 may further include controller 250, application controller 260, and change request processor 270. Controller 250 may be configured to manage the object metadata table processor 210, the field metadata table processor 220, the primary key metadata table processor 230, the second key metadata table processor, and/or storage 280. Application controller 260 may be configured to control an application running on the SaaS application development system 130. Change request processor 270 may be configured to manage change requests in SaaS application development. Application controller 260 and/or change request processor 270 may be configured to control or manage the object metadata table processor 210, the field metadata table processor 220, the primary key metadata table processor 230, the second key metadata table processor, and/or storage 280 via controller 250.

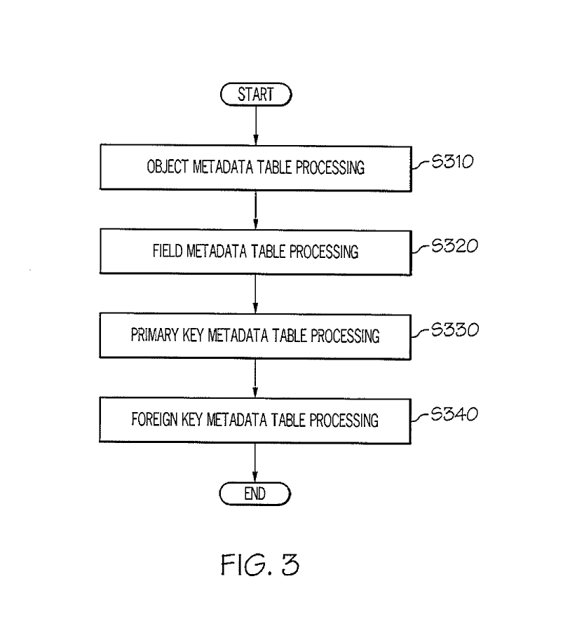

FIG. 3 depicts an example flow diagram of metadata processing according to an embodiment of the present invention. At S310, an object metadata table is processed. At S320, a field metadata table is processed. At S330, a primary key metadata table is processed. At S340, a foreign key metadata table is processed. In certain embodiments, the steps described above may be performed concurrently or in a different order than shown.

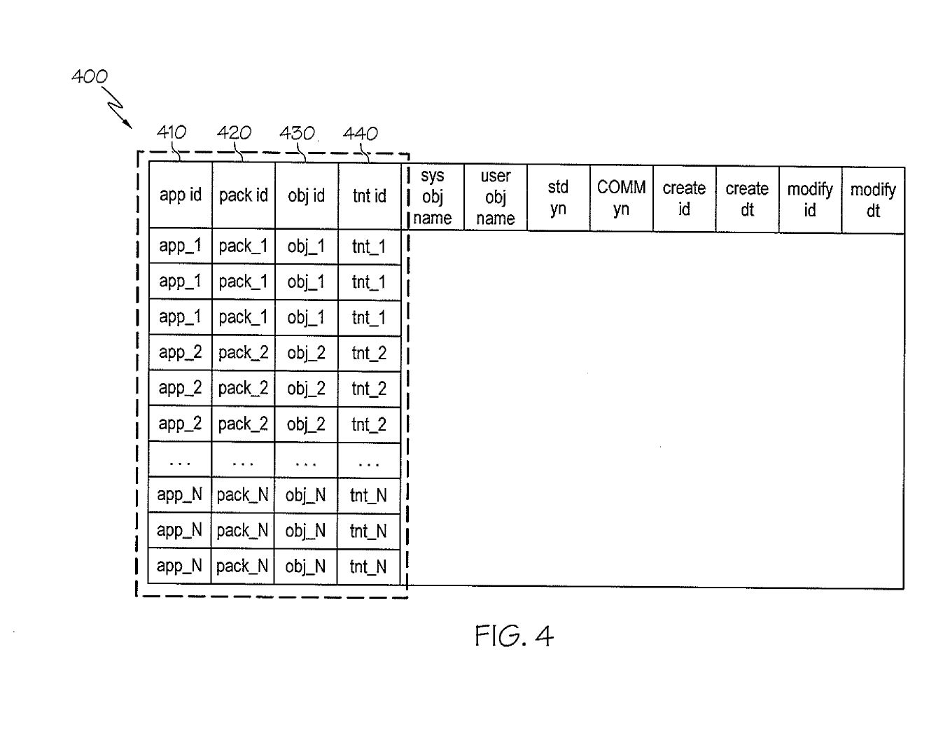

FIG. 4 depicts an example object metadata table schematic 400 according to an embodiment of the present invention. As shown, the object metadata table schematic 400 includes application identifier (app id) 410, package identifier (pack id) 420, object identifier (object id) 430, and tenant identifier (tnt id) 440. Additional example fields of the object metadata table are shown. In certain embodiments, one or more of the example fields shown in the object metadata table schematic 400 may be omitted. Furthermore, one or more additional fields not shown may be included in the object metadata table schematic 400.

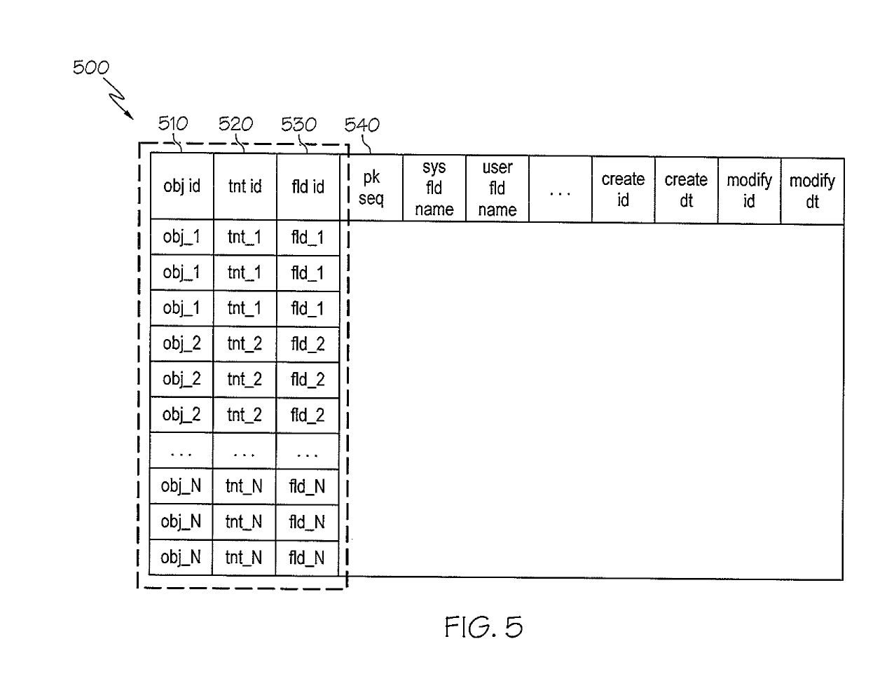

FIG. 5 depicts an example field metadata table schematic 500 according to an embodiment of the present invention. As shown, the field metadata table schematic 500 includes object identifier (object id) 510, tenant identifier (tnt id) 520, field identifier (fld id) 530, and package sequence number (pk seq) 540. Additional example fields of the field metadata table are shown. In certain embodiments, one or more of the example fields shown in the field metadata table schematic 500 may be omitted. Furthermore, one or more additional fields not shown may be included in the field metadata table schematic 500.

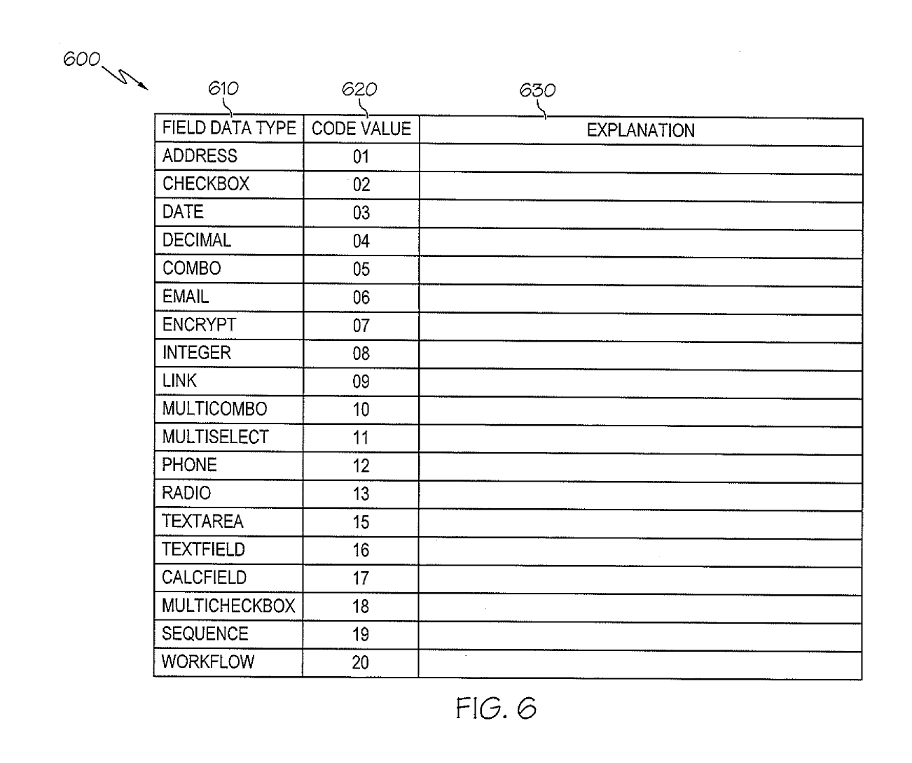

FIG. 6 depicts an example field metadata table 600 according to an embodiment of the present invention. As shown, the field metadata table 600 includes field data type 610, code value 620, explanation (field description) 630. The exemplary field metadata table 600 shown is for illustrative purposes only and not intended to be limiting.

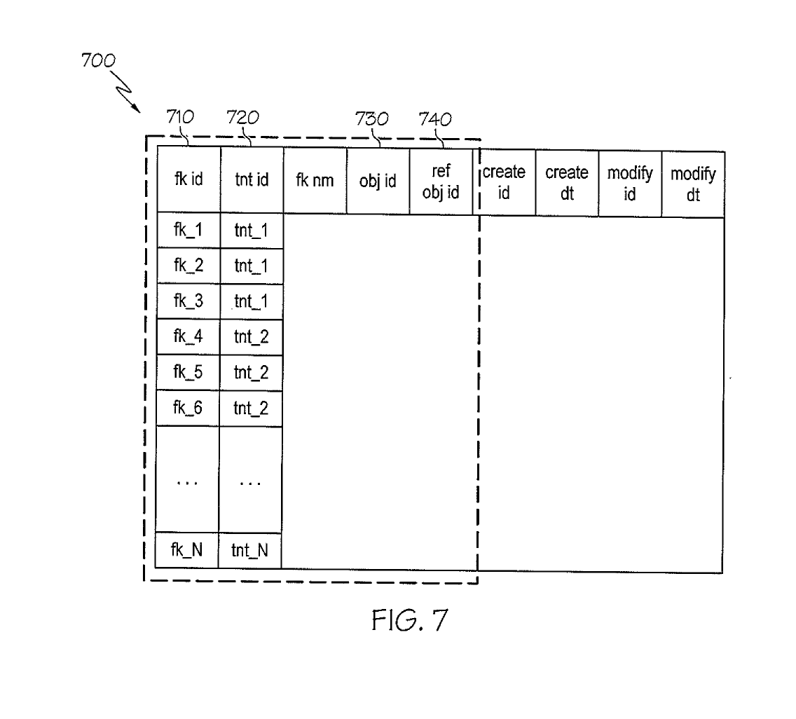

FIG. 7 depicts an example primary key metadata table schematic 700 according to an embodiment of the present invention. As shown, the primary key metadata table schematic 700 includes field key identifier (fk id) 710, tenant identifier (tn tid) 720, object identifier (object id) 730, and reference object identifier (ref obj id) 740.

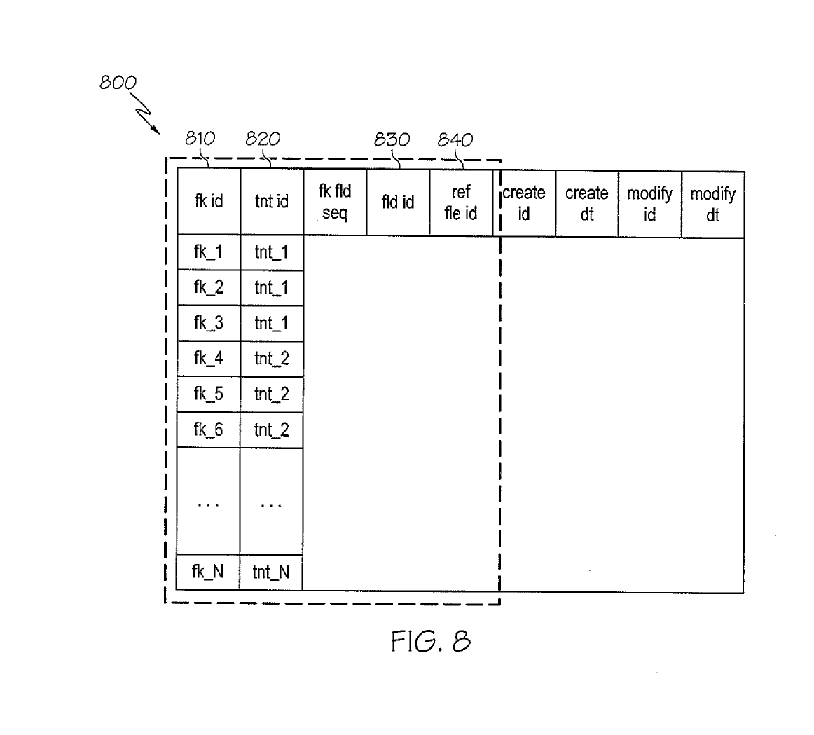

FIG. 8 depicts an example second key metadata table schematic 800 according to an embodiment of the present invention. As shown, the second key metadata table schematic 800 includes field key identifier (fk id) 810, tenant identifier (tn tid) 820, field identifier (fld id) 830, and reference field identifier (ref fld id) 840.

Additional example fields of the primary key metadata table schematic 700 and second key metadata table schematic 800 are shown. In certain embodiments, one or more of the example fields shown in the first metadata table schematic 700 and/or second key metadata table schematic 800 may be omitted. Furthermore, one or more additional fields not shown may be included in the first metadata table schematic 700 and/or second key metadata table schematic 800.

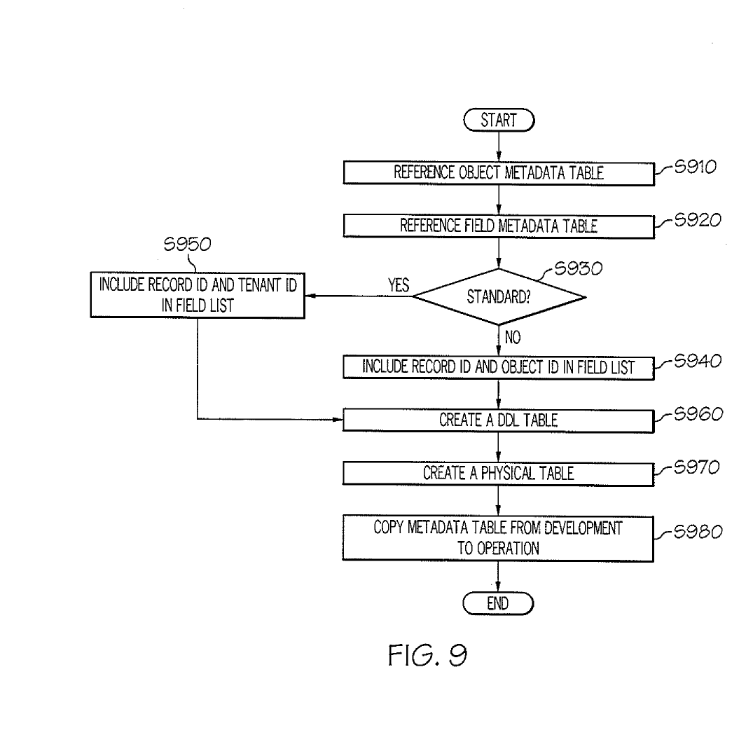

FIG. 9 depicts an example flow diagram for producing the object metadata table according to an embodiment of the present invention. At S910, the object metadata table is referenced. At S920, the field metadata table is referenced. At S930, a determination is made whether the object metadata table is standard or non-standard. If standard, at S950, record identifier and tenant identifier are included in the field list. At S940, record identifier and object identifier are included in the field list. At S960, a data definition language (DDL) table is created. A data definition language or data description language (DDL) is a syntax similar to a computer programming language for defining data structures, especially database schemas. At S970, a physical table is created. At S980, one or more metadata tables are copied from development to an operation area to be performed.

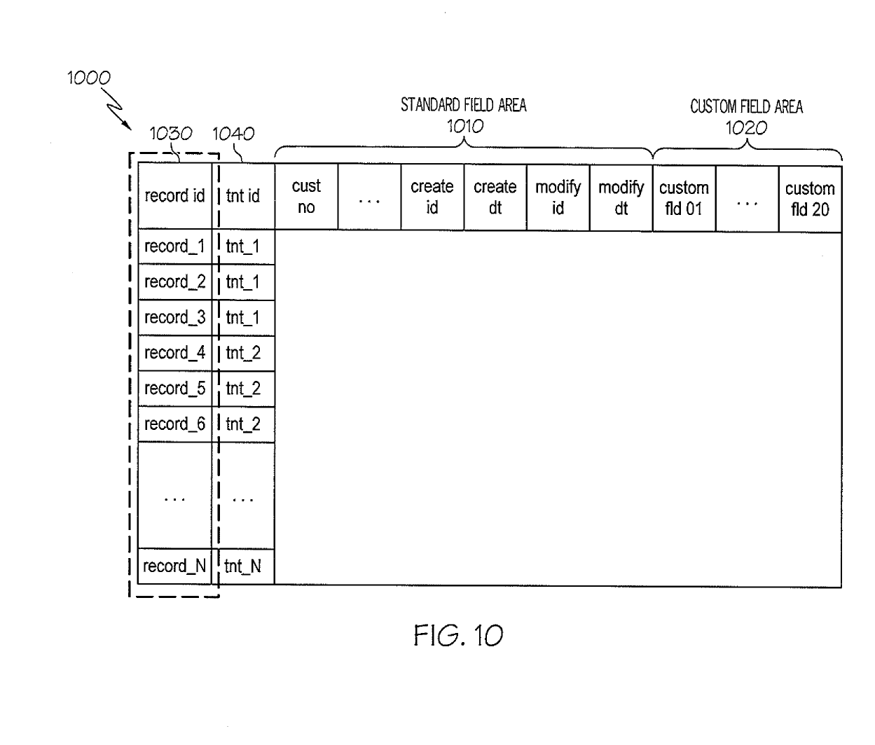

FIG. 10 depicts a standard object metadata table schematic 1000 according to an embodiment of the present invention. As shown, the standard object metadata table schematic 1000 includes a record identifier (record id) 1030 and a tenant identifier (tnt id) 1040. The standard object metadata table schematic 1000 further includes a standard field area 1010 and a custom field area 1020.

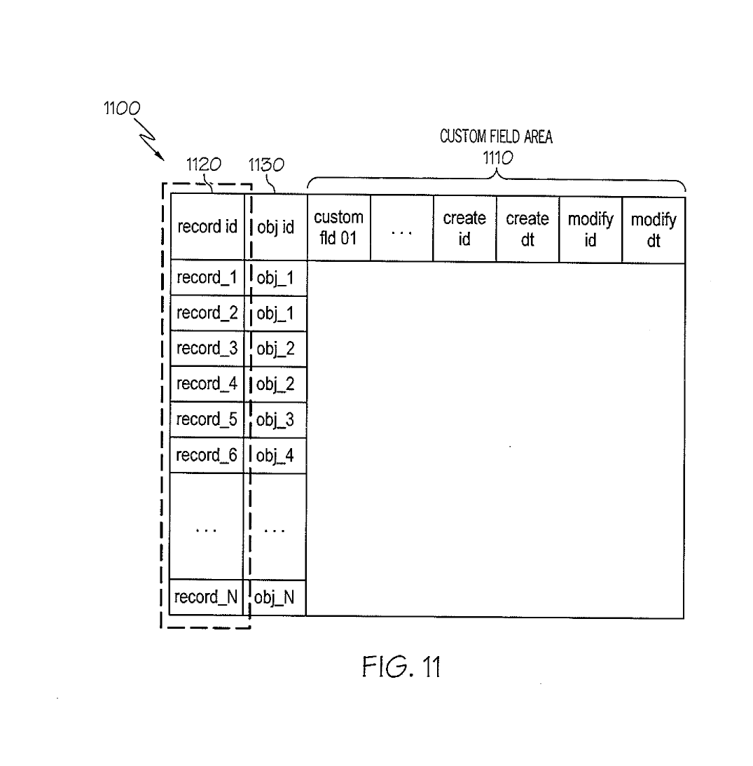

FIG. 11 depicts a non-standard object metadata table schematic 1100 according to an embodiment of the present invention. As shown, the non-standard object metadata table schematic 1100 includes a record identifier (record id) 1120 and an object identifier (obj id) 1130. The non-standard object metadata table schematic 1100 further includes a custom field area 1110. The non-standard object metadata table schematic 1100 does not include a standard field area.

The fields of the standard object metadata table schematic 1000 and non-standard object metadata table schematic 1100 are illustrative only and not intended to be limiting. In certain embodiments, one or more of the example fields shown in the standard object metadata table schematic 1000 and/or non-standard object metadata table schematic 1100 may be omitted. Furthermore, one or more additional fields not shown may be included in the standard object metadata table schematic 1000 and/or non-standard object metadata table schematic 1100.

While shown and described herein as an SaaS application solution in multi-tenancy, it is understood that the invention further provides various alternative embodiments. For example, in one embodiment, the invention provides a computer-readable/useable medium that includes computer program code to enable a computer infrastructure to provide SaaS application generation functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide SaaS application generation functionality. In this case, the service provider can create, maintain, support, etc., a computer infrastructure, such as SaaS application development architecture 100 (FIG. 1) that performs the processes of the invention for one or more tenants or consumers. In return, the service provider can receive payment from the consumer(s) under a subscription and/or fee agreement and/or the service provider can receive payment from the sale of advertising content to one or more third parties.

In still another embodiment, the invention provides a computer-implemented method for generating an SaaS application in a multi-tenant environment. In this case, a computer infrastructure, such as SaaS application development architecture 100 (FIG. 1), can be provided, and one or more systems for performing the processes of the invention can be obtained (e.g., created, purchased, used, modified, etc.) and deployed to the computer infrastructure. To this extent, the deployment of a system can comprise one or more of: (1) installing program code on a computing device, from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A computer-implemented method for providing a metadata-driven software architecture that enables multi-tenant application development, comprising:
referencing a first metadata associated with an object;
referencing a second metadata associated with a field; and
storing an application-accessible data associated with a tenant, wherein the application-accessible data is defined by at least one of the first metadata or the second metadata.

2. The computer-implemented method of claim 1, wherein the application-accessible data is stored in a data table.

3. The computer-implemented method of claim 1, wherein the first metadata is stored in an object metadata table.

4. The computer-implemented method of claim 1, wherein the second metadata is stored in a field metadata table.

5. The computer-implemented method of claim 1, further comprising:
referencing at least one of a primary key metadata associated with a primary key field or a second key metadata associated with a second key field; and
storing the application-accessible data, wherein the application-accessible data is defined by at least one of the first metadata, the second metadata, the primary key metadata, or the second key metadata.

6. The computer-implemented method of claim 1, further comprising creating a tenant application using the application-accessible data.

7. The computer-implemented method of claim 6, wherein the tenant application is an on-demand database service application.

8. A system for providing a metadata-driven software architecture that enables multitenant application development, comprising:
a memory medium comprising instructions;
a bus coupled to the memory medium; and
a processor coupled to the bus that when executing the instructions causes the system to:
reference a first metadata associated with an object;
reference a second metadata associated with a field; and
store an application-accessible data associated with a tenant, wherein the application-accessible data is defined by at least one of the first metadata or the second metadata.

9. The system of claim 8, further comprising a data table configured to store the application-accessible data.

10. The system of claim 8, wherein the first metadata is stored in an object metadata table.

11. The system of claim 8, wherein the second metadata is stored in a field metadata table.

12. The system of claim 8 being further caused to reference at least one of a primary key metadata associated with a primary key field or a second key metadata associated with a second key field and store the application-accessible data, wherein the application-accessible data is defined by at least one of the first metadata, the second metadata, the primary key metadata, or the second key metadata.

13. The system of claim 8 being further caused to create a tenant application using the application-accessible data.

14. The system of claim 13, wherein the tenant application is an on-demand database service application.

15. A computer program product for providing an on-demand database service application composer, the computer program product comprising a computer readable storage media, and program instructions stored on the computer readable storage media, to:
reference a first metadata associated with an object;
reference a second metadata associated with a field; and
store an application-accessible data associated with a tenant, wherein the application-accessible data is defined by at least one of the first metadata or the second metadata.

16. The computer program product of claim 15, the computer readable storage media further comprising instructions to store the application-accessible data in a data table.

17. The computer program product of claim 15, wherein the first metadata is stored in an object metadata table and the second metadata is stored in a field metadata table.

18. The computer program product of claim 15, the computer readable storage media further comprising instructions to reference at least one of a primary key metadata associated with a primary key field or a second key metadata associated with a second key field and store the application-accessible data, wherein the application-accessible data is defined by at least one of the first metadata, the second metadata, the primary key metadata, or the second key metadata.

19. The computer program product of claim 15, the computer readable storage media further comprising instructions to create a tenant application using the application-accessible data.

20. The computer program product of claim 19, wherein the tenant application is an on-demand database service application.
